(19) United States
(12) Patent Application Publication
(10) Pub. No.: US 2015/0293375 A1
(43) Pub. Date: Oct. 15, 2015

(54) Method Of Producing A Spectacle Lens Having A Decorative Element

(71) Applicant: Interglass Technology AG, Cham (CH)

(72) Inventors: Frank Pfeffer, Baar (CH); Christophe Weiteneder, Luzern (CH)

(21) Appl. No.: 14/684,122

(22) Filed: Apr. 10, 2015

(30) Foreign Application Priority Data
Apr. 11, 2014 (CH) 00565/14

(51) Int. Cl. G02C 7/02; G02C 7/10

(52) U.S. Cl. CPC G02C 7/021; G02C 7/10; G02C 2202/16

(57) ABSTRACT

The invention relates to a method of producing a spectacle lens having at least one decorative element such as diamonds, crystals etc. The decorative elements are glued to a piece of foil, the piece of foil is deformed permanently and positioned between two molds and joined into a composite forming a mold cavity. A monomer is then cast into the mold cavity and cured. The molds are then detached.

### PRIORITY CLAIM

Applicant hereby claims foreign priority under 35 U.S.C. §119 from Swiss Application No. 00565/14 filed Apr. 11, 2014, the disclosure of which is herein incorporated by reference.

### FIELD OF THE INVENTION

The invention relates to a method of producing a spectacle lens having a decorative element.

### BACKGROUND OF THE INVENTION

It is known to arrange diamonds or other pieces of jewellery on the spectacle lenses of a spectacle in the region of the edge. These diamonds and pieces of jewellery are obviously very small.

### SUMMARY OF THE INVENTION

The invention relates to a method of producing a spectacle lens having at least one decorative element, wherein the at least one decorative element is cast into the spectacle lens. Such decorative elements are diamonds, crystals, jewels, gemstones and metal pieces for example.

### BRIEF DESCRIPTION OF THE DRAWING FIGURES

The accompanying drawings, which are incorporated into and constitute a part of this specification, illustrate one or more embodiments of the present invention and, together with the detailed description, serve to explain the principles and implementations of the invention. The figures are drawn schematically and not to scale. In the drawings:

FIGS. 1 to 5 show different snapshots during the production method.

### DETAILED DESCRIPTION OF THE INVENTION

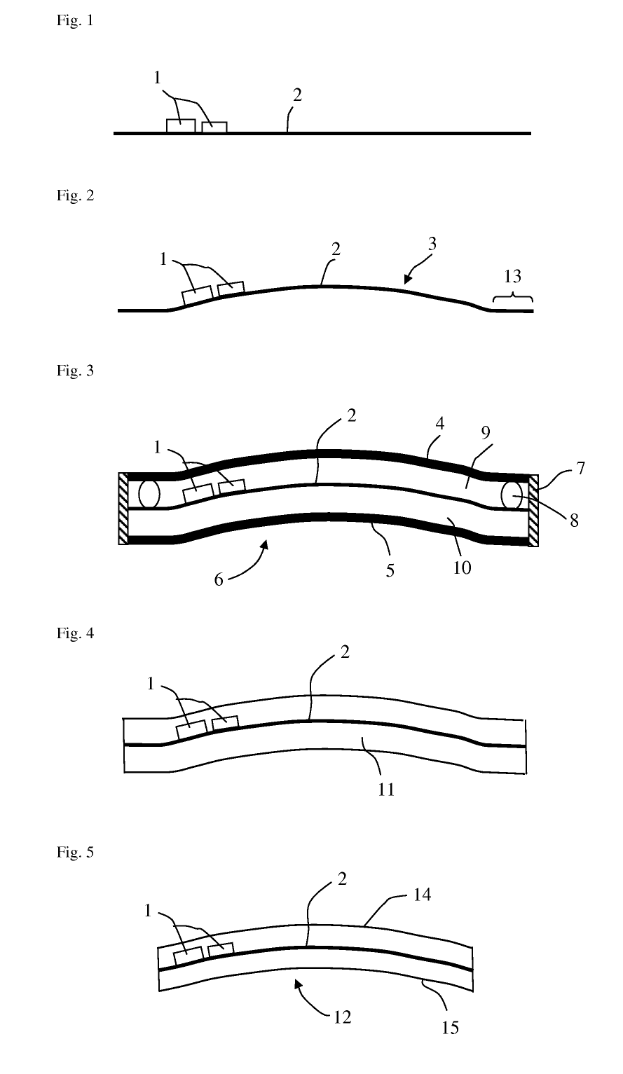

The method in accordance with the invention for producing a spectacle lens having at least one decorative element is explained below in closer detail by reference to the drawings. FIG. 1 shows a snapshot after step A, FIG. 2 shows a snapshot after step B, FIG. 3 shows a snapshot after step D, FIG. 4 shows a snapshot after step G and FIG. 5 shows a snapshot after step H.

The method according to the invention comprises the following steps:
A) applying one or more decorative elements to a planar piece of foil at one or more predetermined positions, thereafter
B) permanently deforming the piece of foil in such a way that at least one region of the piece of foil is a curved surface, thereafter
C) optionally, activating the deformed piece of foil 2, thereafter
D) positioning the deformed piece of foil 2 between a front mold 4 and a rear mold 5 and connecting the piece of foil 2 with the two molds 4, 5 to build a composite 6 in order to form a mold cavity with a pouring opening, wherein the deformed piece of the foil 2 is spaced from the front mold 4 and the rear mold 5, thereafter
E) pouring a monomer into the mold cavity, thereafter
F) curing the monomer into a monomer block 11, thereafter
G) decomposing the composite 6 and thereby detaching the two molds 4, 5 from the monomer block 11, and thereafter
H) cutting the spectacle lens 12 from the monomer block 11.

The spectacle lens 12 is manufactured by casting. The two molds (also called shell molds) thereby define the optical surfaces 14 and 15 of the spectacle lens 12. The at least one decorative element 1 is thereby cast in the interior.

The piece of foil 2 is punched or cut out from a planar foil whose thickness is typically approximately 0.3 mm, but which can also reach from 0.03 mm to 1.2 mm, so that it fits after the deformation between the two molds 4 and 5. The shape of the planar piece of foil 2 after this step is typically round or elliptical.

The decorative elements 1 are preferably applied to the piece of foil 2 by gluing. The decorative elements 1 can also be fixed by other methods to the piece of foil 2, e.g. by melting and/or by means of ultrasonic sound etc.

The deformation of the piece of foil 2 preferably occurs in such a way that a boundary strip 13 of the piece of foil 2 remains planar. The curved surface 3 of the piece of foil 2 can be a spherical surface or an elliptical or toroidal surface, or any other surface adjusted to the application. The deformation of the piece of foil 2 is a permanent deformation.

The activation of the piece of foil 2 is a chemical treatment, especially a plasma treatment, which ensures that the surfaces of the piece of foil 2 can be wetted very well by the monomer and that the cured monomer adheres permanently to the piece of foil 2 without any likelihood of detachment. The activation provides an improvement in the wettability and adhesion in many foils. It is also possible to use foils on the surface of which a so-called primer is applied which acts as a bonding agent. This coating of the foil can also lead to positive wetting and adhesion without requiring the activation of the surface. With some foils, the wettability and the adhesion are sufficient without the need of activation and/or without the need of a primer. In this case the activation or the application of a primer, respectively, may be omitted.

The joining of the piece of foil 2 to the two molds 4 and 5 preferably occurs in that the piece of foil 2 is fixed to the front or the rear mold 4 or 5. In the present embodiment, the piece of foil 2 was fixed by an adhesive 8 to the front mold 4. If the boundary strip 13 of the piece of foil 2 and the molds 4 and 5 are planar, the boundary strip 13 of the piece of foil 2 is fixed at a predetermined distance to one of the two molds 4 or 5, preferably by gluing, and the composite 6 is then formed, e.g. by means of a tape 7 according to the method described in WO 2006/003099, or in any other manner, e.g. by means of a sealing ring. The piece of foil 2 is situated between the two molds 4 and 5 and is separated both from the front mold 4 and also from the rear mold 5 by a respective cavity 9 and 10. These two cavities 9 and 10 form the mold cavity.

After curing the monomer, the composite 6 is disassembled again: at first the tape 7 or the sealing ring and thereafter the two molds 4 and 5 are separated from the monomer block 11 in step G. The monomer block 11 now represents the almost finished spectacle lens 12, its front face 14 and its rear face 15 form the optical surfaces of the spectacle lens 12.

The cutting of the spectacle lens 12 from the monomer block 11 only relates to the circumference of the spectacle lens 12 but not to the optical surfaces since it only remains to adapt the spectacle lens to the eyeglass frame. The cutting can be carried out by the manufacturer of the spectacle lenses or in a specialist optical store.

The foils, from which the piece of foils 2 are punched out, are transparent and of high optical quality. They are colourless for use in normal spectacles or coloured for use in sunglasses. The foils can also have a defined colour progression. The colours produce the tinting of the spectacle lens. Such foils mostly have one layer. The foils can also be polarising foils. Polarising foils mostly have several layers. The foils are covered on both sides by a protective foil which is removed during the production process of the spectacle lenses, i.e. the one protective foil before the application of the decorative element(s) and the other protective foil at the latest before the deformation of the piece of foil 2.

In order to ensure that the decorative elements are situated at the correct location on the spectacle in which the spectacle lenses 12 are inserted, different data must already be known during mounting of the decorative elements on the piece of foil 2, i.e. data on the shape and size of the spectacle frame, data on the optical properties of the spectacle lens et cetera. In the case of polarising foils, the polarisation direction needs to be considered further, so that the polarisation direction of the spectacle lenses 12 extends in a defined direction when the spectacles are completely mounted.

The spectacle lenses 12 can also be without an optical effect.

As can be seen from the method described above, the term “spectacle lens” does not mean that the spectacle lens actually consists of glass. Rather, the spectacle lens consists of a hardened monomer, i.e. of a synthetic material.

The invention offers several advantages:

The decorative elements are situated in the interior of the spectacle lens and are thus protected from damage or loss.

The decorative elements are situated on the side of the foil facing the front side of the spectacle lenses. In the case of sunglasses, they are thus situated in front of the tinting produced by the piece of foil, whereas they are situated behind the tinting in conventional sunglasses. They thus maintain their own colour and their full luminosity.

The surface of the spectacle lens is smooth and homogeneously enclosed on all sides, i.e. it is like a polished surface. As a result, the spectacle lenses can be cleaned in a highly convenient manner like spectacles with conventional lenses, which is in contrast to spectacle lenses having decorative elements that are attached to the surface.

The two surfaces of the spectacle lens which form its optical surfaces need not be ground.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims and their equivalents.

What is claimed is:

1. A method of producing a spectacle lens having at least one decorative element, comprising the following steps:
applying one or more decorative elements to a planar piece of foil at one or more predetermined positions, thereafter
permanently deforming the piece of foil in such a way that at least one region of the piece of foil is a curved surface, thereafter
positioning the deformed piece of foil between a front mold and a rear mold and connecting the piece of foil with the two molds to build a composite in order to form a mold cavity with a pouring opening, wherein the deformed piece of the foil is spaced from the front mold and the rear mold, thereafter
pouring a monomer into the mold cavity, thereafter
curing the monomer into a monomer block, thereafter
decomposing the composite and thereby detaching the two molds from the monomer block, and thereafter
cutting the spectacle lens from the monomer block.

2. The method according to claim 1, wherein the piece of foil is deformed in such a way that a boundary strip of the piece of foil remains planar.

3. The method according to claim 1, wherein the piece of foil is activated by a chemical treatment.

4. The method according to claim 2, wherein the piece of foil is activated by a chemical treatment.

5. A spectacle lens with at least one decorative element, wherein the at least one decorative element is completely situated in the interior of the spectacle lens, so that the at least one decorative element is separated by a monomer layer from the front face and the rear face of the spectacle lens.

6. The spectacle lens according to claim 5, wherein the spectacle lens has a tinting and the at least one decorative element is situated before the tinting.
